(19) United States
(12) Patent Application Publication
(10) Pub. No.: US 2022/0081866 A1
(43) Pub. Date: Mar. 17, 2022

(54) RIDGE WITH ECOLOGICAL ISOLATION ZONE AND CONSTRUCTION METHOD THEREOF

(71) Applicants: Yunnan Agricultural University, Kunming City (CN); Kunming Changshui International Airport, Yunnan Airport Group, Kunming City (CN)

(72) Inventors: Shuxia LIU, Kunming City (CN); Wanchun XU, Kunming City (CN); Honggang ZHENG, Kunming City (CN); Gengjie ZHANG, Kunming City (CN); Chuan ZHANG, Kunming City (CN); Jianxin YU, Kunming City (CN)

(21) Appl. No.: 17/019,729

(22) Filed: Sep. 14, 2020

(51) Int. Cl. E02D 17/20; A01B 79/02

(52) U.S. Cl. CPC E02D 17/202; A01G 22/00; A01B 79/02

(57) ABSTRACT

A ridge with an ecological isolation zone and a construction method thereof. The method includes: (1) spreading a geotextile on the bottom of a trimmed ridge; (2) stacking reinforced soil on the geotextile; (3) folding the geotextile from the end away from the ridge upwards and inwards to wrap the reinforced soil; (4) continuing to stack the reinforced soil on the folded end of the geotextile, and then trimming to form a first layer of reinforced soil ridge-protection structure; (5) repeating steps (1) to (4) to further construct multiple layers of reinforced soil ridge-protection structure. The present invention no longer uses an ecological bag to pack a soil mixture, and thus can reduce the cost of construction. Moreover, owing to the separation of geotextile and the consolidation of reinforced soil between two adjacent layers of reinforced soil ridge-protection structure, a more stable ridge structure is formed.

### BACKGROUND OF THE INVENTION

### 1. Field of the Invention

The present invention relates to the field of ecological terraces, and in particular, to a ridge with an ecological isolation zone and a construction method thereof.

### 2. Description of Related Art

It can been from many land reclamation projects implemented in mountainous and hilly areas of southwest China that not enough attention has been paid to the construction of ridges in most of the projects, most adopting soil ridges, and some involving the construction of stone ridges (the use of stone ridges is relatively common in Sichuan province). For the traditional reclamation of slope land, machinery is generally used to trim the slope land to terraces, and build footpaths and ridges to protect the slope farmland. The ridges include soft ridges, hard ridges, compound ridges, stone ridges or the like. The footpaths and ridges are made from local materials, resulting in low cost and convenient construction. However, due to the low stability, slow vegetation recovery, serious collapse after a period of use, large infiltration, severe soil erosion, high maintenance cost, large land occupation, low utilization rate, and short life span of the constructed terrace ridges, the local soil and water conservation and the healthy development of the ecological environment are directly compromised.

Therefore, it is necessary to propose a technology achieving the complementation between near-ecological ridges and the nature, which combines the natural characteristics of the local land to realize the construction of ridges with excellent stability, high utilization and rapid vegetation restoration. The technology achieving the complementation between near-ecological ridges and the nature mainly involves the construction of ridges with excellent stability, high utilization and rapid vegetation cover on slope farmland by combining the natural characteristics and using some special materials that have little negative impact on the ecological environment. For example, a mixture of soil, humic substances, a soil conditioner and a plant seed mixture with a certain ratio was wrapped in an ecological bag, and then stacked and fixed to form the near-ecological model of a ridge. However, as the ecological bags connect with each other completely relying on the ecological bag material, the misalignment of the ecological bags may still occur, which will result in the reduced stability of the ridge. Moreover, the process for filling an ecological bag is cumbersome, which results in a higher construction cost.

### SUMMARY OF THE INVENTION

The present invention is intended to provide a ridge with an ecological isolation zone and a construction method thereof for solving the above-mentioned problems in the prior art. The present invention no longer uses an ecological bag to pack a soil mixture, and thus can reduce the cost of construction. Moreover, owing to the separation of geotextile and the consolidation of reinforced soil between two adjacent layers of reinforced soil ridge-protection structure, a more stable ridge structure is formed.

To achieve the above purpose, the present invention provides the following technical solutions.

The present invention provides a method for constructing a ridge with an ecological isolation zone, including the following steps:

(1) spreading a geotextile on the bottom of a trimmed ridge;

(2) stacking reinforced soil on the geotextile;

(3) folding the geotextile from the end away from the ridge upwards and inwards to wrap the reinforced soil;

(4) continuing to stack the reinforced soil on the folded end of the geotextile, and then trimming to form a first layer of reinforced soil ridge-protection structure; and

(5) repeating steps (1) to (4) to further construct multiple layers of reinforced soil ridge-protection structure.

Preferably, in step (1), the geotextile is a non-woven geotextile, with a mass standard of 200 g/m³ to 300 g/m³; and one or more pieces of the geotextile are spread along the lengthwise direction of the ridge.

Preferably, in step (2), the reinforced soil is a soil admixed with a seed mixture and a soil structure-reinforcing agent.

Preferably, the seed mixture includes whitetip clover, astragalus, and alfalfa seeds.

Preferably, in step (3), the geotextile wraps the reinforced soil to form a bulge, and the reinforced soil inside the bulge is connected with the reinforced soil stacked in step (4) to form a structure in which the bent end of the geotextile is buried in the reinforced soil.

Preferably, in step (5), each layer of reinforced soil ridge-protection structure has a thickness of 300 mm to 500 mm.

Preferably, the geotextile on which the reinforced soil is stacked has a width of at least 400 mm.

Preferably, the ridge has an inclination angle of 65° to 80°.

The present invention further provides a ridge with an ecological isolation zone, wherein: the ridge is constructed by the above method for constructing a ridge with an ecological isolation zone, and includes multiple layers of reinforced soil ridge-protection structure; and each layer of reinforced soil ridge-protection structure includes a geotextile and reinforced soil wrapped in the geotextile.

Preferably, the geotextile wraps the reinforced soil to form a bulge, and the reinforced soil inside the bulge is connected with the reinforced soil outside the bulge.

Compared with the prior art, the present invention achieves the following technical effects:

(1) In the present invention, the geotextile is folded upwards and inwards from one end to wrap the stacked reinforced soil to form multiple layers of reinforced soil ridge-protection structure. Owing to the separation of geotextile and the connection of reinforced soil between two adjacent layers of reinforced soil ridge-protection structure, a more stable ridge structure is formed. Moreover, the reinforced soil ridge-protection structure is connected with the original ridge via reinforced soil to further improve the stability of the connection between the new ridge structure and the original ridge structure, which is beneficial to improve the strength of the ridge, reduce the land occupation of the ridge to a certain degree, and increase the effective utilization of cultivated land and the efficiency of agricultural production while preventing soil erosion and improving the ecological environment.

(2) The present invention no longer needs to use ecological bags for packing, but uses a geotextile for large-area construction in the lengthwise direction of the ridge; and the soil can be stacked using engineering machinery, which can significantly reduce the workload and improve the efficiency of construction.

(3) The present invention uses a degradable and non-toxic non-woven geotextile with high tensile strength to wrap reinforced soil admixed with a seed mixture and a soil structure-reinforcing agent, and the ridge will eventually return to a near-natural state where the ridge is covered with vegetation, which is beneficial to improve the strength of the ridge, reduce the land occupation of the ridge to a certain degree, and effectively increase the effective utilization of cultivated land and the efficiency of agricultural production while preventing soil erosion on slopes and improving the regional ecological environment.

(4) The ridge structure of the present invention has a stability increased by more than 20%, and results in an erosion modulus below 500 t/a·km², a soil moisture content increased by more than 20%, a vegetation coverage for farmland increased by 16%, and a vegetation coverage for ridge of more than 90%.

### BRIEF DESCRIPTION OF DRAWINGS

To describe the technical solutions in the examples of the present invention or in the prior art more clearly, the following briefly introduces the accompanying drawings required for describing the examples. Apparently, the accompanying drawings in the following description show merely some examples of the present invention, and a person of ordinary skill in the art may still derive other drawings from these accompanying drawings without creative efforts.

FIG. 1 is a sectional view for the ridge structure according to the present invention.

In the FIGURE: 1 denotes reinforced soil; 2 denotes geotextile; 3 denotes bulge; 4 denotes the upper field surface; and 5 denotes the lower field surface.

### DETAILED DESCRIPTION OF THE INVENTION

The technical solutions in the examples of the present invention are clearly and completely described below with reference to the accompanying drawings in the examples of the present invention. Apparently, the described examples are merely a part rather than all of the examples of the present invention. All other examples obtained by a person of ordinary skill in the art based on the examples of the present invention without creative efforts shall fall within the protection scope of the present invention.

The present invention is intended to provide a ridge with an ecological isolation zone and a construction method thereof for solving the problems existing in the prior art. The present invention no longer uses an ecological bag to pack a soil mixture, and thus can reduce the cost of construction. Moreover, owing to the separation of geotextile and the consolidation of reinforced soil between two adjacent layers of reinforced soil ridge-protection structure, a more stable ridge structure is formed.

In order to make the above objectives, features and advantages of the present invention more understandable, the present invention will be described in further detail below with reference to the accompanying drawings and detailed examples.

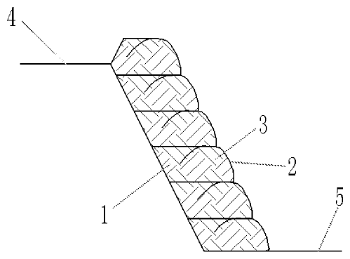

The present invention provides a method for constructing a ridge with an ecological isolation zone. With reference to FIG. 1, the method includes the following steps:

(1) An existing ridge was trimmed to have an inclined cross-section structure, where, the inclination angle of the cross-section structure was determined by calculation, which should be less than the natural angle of repose to further ensure the stability of the ridge subsequently stacked with reinforced soil 1; and then a geotextile 2 was spread on the bottom of the trimmed ridge, where, it should be noted that the geotextile 2 had a lengthwise direction parallel to the lengthwise direction of the ridge, and a calculated width that enables the wrapping of the reinforced soil 1 to form a layer of reinforced soil ridge-protection structure.

(2) The reinforced soil 1 was stacked on the geotextile 2, where, the reinforced soil 1 could be stacked on the geotextile 2 with large engineering machinery and connected with the original ridge; after the seeds in the reinforced soil 1 grew to form vegetation, the roots of the vegetation would further penetrate into the original ridge structure to form a more stable ridge structure; and a certain width was reserved at the end of the geotextile 2 away from the original ridge, which could be calculated according to the height and width of the designed single layer of reinforced soil ridge-protection structure, and should be at least greater than the height of the stacked reinforced soil 1 to enable the wrap structure.

(3) The geotextile 2 was folded upwards and inwards from the end away from the ridge to wrap the reinforced soil 1, where, it should be noted that the wrapped reinforced soil 1 could be trimmed to have a flat surface to facilitate the further spreading of the geotextile 2 for the construction of the next layer; moreover, the folded geotextile 2 must be pressed by the geotextile 2 to be spread or the reinforced soil 1; and at that time, the folded geotextile 2 was parallel to the flat surface obtained after the trimming or had a downwardly-curved structure.

(4) The reinforced soil 1 was further stacked on the folded end of the geotextile 2 to press the folded geotextile 2, and then the surface was trimmed to form a first layer of reinforced soil ridge-protection structure.

(5) Steps (1) to (4) were repeated to further construct multiple layers of reinforced soil ridge-protection structure.

The geotextile 2 used in the construction of step (1) is a non-woven geotextile, with a mass standard of 200 g/m³ to 300 g/m³, which has advantages, such as degradability, non-toxicity, and high tensile strength. In actual construction, one or more pieces of the geotextile 2 are spread along the lengthwise direction of the ridge according to actual conditions or construction requirements, and when multiple pieces are spread, two adjacent pieces of the geotextile 2 should overlap with each other to form an overall structure.

In step (2), the reinforced soil 1 is a soil admixed with a seed mixture and a soil structure-reinforcing agent. The soil structure-reinforcing agent is an agent that can change the soil aggregate structure and improve the chemical properties of the soil to increase the stability of the soil mass, which has functions similar to a soil conditioner. The soil structure-reinforcing agent is specifically added according to the characteristics of the local soil structure, and specifically includes ingredients, such as minerals, natural and semi-synthetic water-soluble polymers, synthetic polymers or beneficial microorganism preparations.

In addition, the added seed mixture should also be selected according to the local climate and soil conditions to enable the thriving of the corresponding plants, and for example, in the dry and hot valley area in Yunnan, the seed mixture mainly includes whitetip clover, astragalus, alfalfa, and other seeds, which are generally mixed at a specific ratio of 1:1:1. Therefore, the present invention uses a degradable and non-toxic non-woven geotextile with high tensile strength to wrap the reinforced soil 1 admixed with a seed mixture and a soil structure-reinforcing agent, and the ridge will eventually return to a near-natural state where the ridge is covered with vegetation, which is beneficial to improve the strength of the ridge, reduce the land occupation of the ridge to a certain degree, and effectively increase the effective utilization of cultivated land and the efficiency of agricultural production while preventing soil erosion on slopes and improving the regional ecological environment.

As shown in FIG. 1, in step (3), the geotextile 2 wraps the reinforced soil 1 to form a bulge 3, and the bulge 3 is an arc-shaped wrap structure. The reinforced soil 1 inside the bulge 3 is connected with the reinforced soil 1 stacked in step (4) to form a structure in which the bent end of the geotextile 2 is buried in the reinforced soil 1. The buried structure can be called a buried end, and the reinforced soil 1 pressed on the buried end will press the buried end downwards, at which point, the bulge 3 forms a stable bulge 3 depending on the strength of the geotextile 2 itself, providing a force opposite to the downward pressing force to maintain the stability of the overall structure. That is, the present invention forms multiple layers of reinforced soil ridge-protection structure by wrapping the stacked reinforced soil 1 inside the geotextile 2, and owing to the separation of geotextile 2 and the connection of reinforced soil 1 between two adjacent layers of reinforced soil ridge-protection structure, a more stable ridge structure is formed. Moreover, the reinforced soil ridge-protection structure is connected with the original ridge via reinforced soil 1 to further improve the stability of the connection between the new ridge structure and the original ridge structure, which is beneficial to improve the strength of the ridge, reduce the land occupation of the ridge to a certain degree, and increase the effective utilization of cultivated land and the efficiency of agricultural production while preventing soil erosion and improving the ecological environment.

Further, in step (5), each layer of reinforced soil ridge-protection structure has a thickness of 300 mm to 500 mm, and correspondingly, the width of the geotextile 2 is designed according to the thickness of each layer of reinforced soil ridge-protection structure to enable the formation of the aforementioned buried end and bulge 3.

The geotextile 2 on which the reinforced soil 1 is stacked has a width of at least 400 mm to enable the formation of a stable bulge 3, which improves the stability of the reinforced soil ridge-protection structure, and thus improves the stability of the overall ridge.

The constructed ridge has an inclination angle of 65° to 80°, which can be smaller than the natural angle of repose, that is, the angle range can better ensure the stability of the ridge.

As shown in FIG. 1, the present invention also provides a ridge with an ecological isolation zone, which is constructed by the method for constructing a ridge with an ecological isolation zone described above. A ridge with an ecological isolation zone is constructed between the upper field surface 4 and the lower field surface 5; the ridge includes multiple layers of reinforced soil ridge-protection structure; and each layer of reinforced soil ridge-protection structure includes the geotextile 2 and reinforced soil 1 wrapped in the geotextile 2. Owing to the separation of geotextile 2 and the connection of reinforced soil 1 between two adjacent layers of reinforced soil ridge-protection structure, a more stable ridge structure is formed. Moreover, the reinforced soil ridge-protection structure is connected with the original ridge via reinforced soil 1 to further improve the stability of the connection between the new ridge structure and the original ridge structure, which is beneficial to improve the strength of the ridge, reduce the land occupation of the ridge to a certain degree, and increase the effective utilization of cultivated land and the efficiency of agricultural production while preventing soil erosion and improving the ecological environment.

The geotextile 2 wraps the reinforced soil 1 to form a bulge 3. The reinforced soil 1 inside the bulge 3 is connected with the reinforced soil 1 stacked outside to form a structure in which the bent end of the geotextile 2 is buried in the reinforced soil 1. The buried structure can be called a buried end, and the reinforced soil 1 pressed on the buried end will press the buried end downwards, at which point, the bulge 3 forms a stable bulge 3 depending on the strength of the geotextile 2 itself, providing a force opposite to the downward pressing force to maintain the stability of the overall structure.

For the ridge of the present invention, the geotextile 2 is a non-woven geotextile, with a mass standard of 200 g/m³ to 300 g/m³, and one or more pieces of the geotextile are spread along the lengthwise direction of the ridge; the reinforced soil 1 is a soil admixed with a seed mixture and a soil structure-reinforcing agent, and the seed mixture includes whitetip clover, astragalus, and alfalfa seeds; each layer of reinforced soil ridge-protection structure has a thickness of 300 mm to 500 mm; the geotextile 2 on which the reinforced soil 1 is stacked has a width of at least 400 mm; and the ridge has an inclination angle of 65° to 80°.

The ridge structure of the present invention has a stability that can increase by more than 20%, and results in an erosion modulus below 500 t/a·km², a soil moisture content increased by more than 20%, a vegetation coverage for farmland increased by 16%, and a vegetation coverage for ridge of more than 90%.

Specific examples are used for illustration of the principles and implementations of the present invention. The description of the examples is used to help illustrate the method and its core principles of the present invention. In addition, those skilled in the art can make various modifications in terms of specific implementations and scope of application according to the teachings of the present invention. In conclusion, the content of this specification shall not be construed as a limitation to the present invention.

What is claimed is:

1. A method for constructing a ridge with an ecological isolation zone, the method comprising:
(1) spreading a geotextile on the bottom of a trimmed ridge;
(2) stacking reinforced soil on the geotextile;
(3) folding the geotextile from the end away from the ridge upwards and inwards to wrap the reinforced soil;
(4) continuing to stack the reinforced soil on the folded end of the geotextile, and then trimming to form a first layer of reinforced soil ridge-protection structure; and
(5) repeating steps (1) to (4) to further construct multiple layers of reinforced soil ridge-protection structure.

2. The method according to claim 1, wherein in step (1), the geotextile is a non-woven geotextile, with a mass standard of 200 g/m³ to 300 g/m³, and one or more pieces of the geotextile are spread along the lengthwise direction of the ridge.

3. The method according to claim 1, wherein in step (2), the reinforced soil is a soil admixed with a seed mixture and a soil structure-reinforcing agent.

4. The method according to claim 3, wherein the seed mixture comprises whitetip clover, astragalus, and alfalfa seeds.

5. The method according to claim 3, wherein in step (3), the geotextile wraps the reinforced soil to form a bulge, and the reinforced soil inside the bulge is connected with the reinforced soil stacked in step (4) to form a structure in which the bent end of the geotextile is buried in the reinforced soil.

6. The method according to claim 1, wherein in step (5), each layer of reinforced soil ridge-protection structure has a thickness of 300 mm to 500 mm.

7. The method according to claim 2, wherein in step (5), each layer of reinforced soil ridge-protection structure has a thickness of 300 mm to 500 mm.

8. The method according to claim 3, wherein in step (5), each layer of reinforced soil ridge-protection structure has a thickness of 300 mm to 500 mm.

9. The method according to claim 4, wherein in step (5), each layer of reinforced soil ridge-protection structure has a thickness of 300 mm to 500 mm.

10. The method according to claim 5, wherein in step (5), each layer of reinforced soil ridge-protection structure has a thickness of 300 mm to 500 mm.

11. The method according to claim 6, wherein the geotextile on which the reinforced soil is stacked has a width of at least 400 mm.

12. The method according to claim 6, wherein the ridge has an inclination angle of 65° to 80°.

13. A ridge with an ecological isolation zone, which is constructed by the method according to claim 1, the ridge comprising:
multiple layers of reinforced soil ridge-protection structure, wherein each layer of reinforced soil ridge-protection structure comprises a geotextile and reinforced soil wrapped in the geotextile.

14. A ridge with an ecological isolation zone, which is constructed by the method according to claim 2, the ridge comprising:
multiple layers of reinforced soil ridge-protection structure, wherein each layer of reinforced soil ridge-protection structure comprises a geotextile and reinforced soil wrapped in the geotextile.

15. A ridge with an ecological isolation zone, which is constructed by the method according to claim 3, the ridge comprising:
multiple layers of reinforced soil ridge-protection structure, wherein each layer of reinforced soil ridge-protection structure comprises a geotextile and reinforced soil wrapped in the geotextile.

16. A ridge with an ecological isolation zone, which is constructed by the method according to claim 4, the ridge comprising:
multiple layers of reinforced soil ridge-protection structure, wherein each layer of reinforced soil ridge-protection structure comprises a geotextile and reinforced soil wrapped in the geotextile.

17. A ridge with an ecological isolation zone, which is constructed by the method according to claim 5, the ridge comprising:
multiple layers of reinforced soil ridge-protection structure, wherein each layer of reinforced soil ridge-protection structure comprises a geotextile and reinforced soil wrapped in the geotextile.

18. A ridge with an ecological isolation zone, which is constructed by the method according to claim 6, the ridge comprising:
multiple layers of reinforced soil ridge-protection structure, wherein each layer of reinforced soil ridge-protection structure comprises a geotextile and reinforced soil wrapped in the geotextile.

19. A ridge with an ecological isolation zone, which is constructed by the method according to claim 11, the ridge comprising:
multiple layers of reinforced soil ridge-protection structure, wherein each layer of reinforced soil ridge-protection structure comprises a geotextile and reinforced soil wrapped in the geotextile.

20. The ridge according to claim 13, wherein the geotextile wraps the reinforced soil to form a bulge, and the reinforced soil inside the bulge is connected with the reinforced soil outside the bulge.
